(19) United States
(12) Patent Application Publication
(10) Pub. No.: US 2007/0110636 A1
(43) Pub. Date: May 17, 2007

(54) Device supplying process gas and related method

(76) Inventors: Hyun-Wook Lee, Suwon-si (KR); Bong-Chun Cho, Hwaseong-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/439,292

(22) Filed: May 24, 2006

(30) Foreign Application Priority Data
Nov. 17, 2005 (KR) 2005-110106

(51) Int. Cl. B32B 5/02

(52) U.S. Cl. 422/110; 422/107; 422/111

(57) ABSTRACT

A reaction gas supplying comprising an MFC and adapted to sense when there is an error in the MFC, and a related method are disclosed. The reaction gas supplying device comprises a gas supply line disposed between a process chamber and a gas supplying element, a mass flow controller adapted to control a supply amount and a supply time of a gas, and a digital pressure gauge adapted to measure the pressure of the gas. The device further comprises a database, and a controller adapted to generate and output a first flow rate control signal, compare the measured pressure value of the gas with a standard pressure value stored in the database corresponding to the first flow rate control signal, and output an alarm generation control signal when the measured pressure value of the gas is outside of a set error range around the standard pressure value.

### BACKGROUND OF THE INVENTION

1. Field of the Invention

Embodiments of the invention relate to a device adapted to supply reaction gas and a related method. More particularly, embodiments of the invention relate to reaction gas supply device adapted to sense errant operation of a related mass flow controller.

This application claims priority to Korean Patent Application No. 10-2005-0110106, filed Nov. 17, 2005, the subject matter of which is hereby incorporated by reference in its entirety.

2. Description of the Related Art

Generally, semiconductor devices are manufactured by performing a complex sequence of fabrication processes. Exemplary fabrication processes include processes related to photolithography, diffusion, etching, oxidation, chemical vapor deposition, and metallic wire formation, etc. Many of these fabrication processes require the application of one or more reaction gases, transport gases, cleaning gases, etc. These gases must be introduced into (i.e., supplied), reacted within, and subsequently removed (i.e., exhausted) from certain specialized process chambers adapted to various fabrication processes in a highly controlled manner.

In order accomplish the selective supply and exhaust of gases from a process chamber, the chamber is typically configured with a so-called gas supplying device and a gas exhausting device. Conventional reaction gas supplying devices comprise a gas supplying element, a gas supply line adapted to supply the reaction gas to the process chamber, and a mass flow controller (MFC). In many instances, different reaction gases will each be associated with corresponding gas supplying devices.

Supplying gas at a desired flow rate to a process chamber during a defined time interval is an important factor in the successful manufacture of semiconductor devices. Recognizing that the fabrication of any particular semiconductor device is actually a carefully controlled sequence of different processes, the sequence is usually defined by a timed series of intervals during which one or more gases is supplied to the process chamber at defined flow rates. For example, a 100-second process interval may be defined such that a first gas having a flow rate of 30 LPM is supplied to the process chamber for the first 20 seconds, a second gas having a flow rate of 50 LPM is supplied to the process chamber for the next 40 seconds, and a third gas having a flow rate of 80 LPM is supplied to the process chamber for the next 40 seconds. A single MFC may be used in conjunction with a single gas supply line to introduce multiple gases at a different flow rate into a process chamber in a highly controlled manner. Since even a slight variation in the gas flow rate may greatly influence the constituent fabrication process being performed in the chamber, gas flow rate must be carefully controlled.

FIG. 1 is a schematic view showing a conventional reaction gas supplying device adapted for use in the fabrication of semiconductor devices. The conventional reaction gas supplying device is connected to a process chamber 10. Since most fabrication processes requires a very high level of gas purity, process chamber 10 is manufactured to isolate the various processes from the external environment. The conventional reaction gas supplying device comprises a gas supplying element 12, a main valve 14, a main pressure regulator and gauge 16, a secondary pressure regulator 18, a digital pressure gauge 20, and an MFC 22. Process chamber 10 receives one or more gases related to a current fabrication process. Gas supplying element 12 stores a process gas, and main valve 14 controls the supply of the process gas. When main valve 14 is open, main pressure regulator and gauge 16 primarily adjusts the pressure (i.e., main pressure) of the process gas being supplied through a gas supply line 24 and displays the adjusted pressure using an analog display. Secondary pressure regulator 18 secondarily adjusts the pressure of the gas supplied through main pressure regulator and gauge 16. Digital pressure gauge 20 digitally displays the secondarily adjusted pressure of gas received from secondary pressure regulator 18. MFC 22 further controls amount of process gas supplied to process chamber 10 and precisely controls the supply interval of the process gas.

As shown in FIG. 1, gas supply line 24 is connected at one end to process chamber 10 in order to supply the process gas. MFC 22 is disposed along gas supply line 24 and adjusts the supply amount and the supply interval of the process gas. Gas supplying element 12 is disposed at the other end of gas supply line 24 and stores the process gas to be supplied to process chamber 10.

Main valve 14 will be closed during maintenance periods for gas supply line 24, process chamber 10, and MFC 22, but is usually open otherwise. As noted above, when main valve 14 is open, main pressure regulator and gauge 16 and secondary pressure regulator 18 cooperate to adjust the supply pressure to MFC 22. In one embodiment, primary pressure may be adjusted to a range of about 8 kgf/cm², and secondarily pressure may be adjusted to 3 kgf/cm².

The amount of process gas supplied to process chamber 10 will vary by process, gas concentration, gas density, and reaction time of the materials on a wafer being processed. In order to avoid over-reactions and under-reactions between the process gas and the wafer materials, and thereby impair the quality of the material layers on the wafer, the operation of MFC 22 must be very precise and a sufficiently durable over extended periods to ensure proper supply flow rates and well controlled supply intervals.

However, as the performance of MFC 22 deteriorates with age or use, it becomes increasingly difficult to reliably determine its exact operating nature. Often, a failing MFC 22 is first noticed when one or more processed wafers turns up malformed.

### SUMMARY OF THE INVENTION

Embodiments of the invention provide a reaction gas supplying device and related method of operation adapted to sense errant operation of a mass flow controller (MFC) before damage to processed wafers can occur.

In one embodiment, the invention provides a reaction gas supplying device comprising a gas supply line disposed between a process chamber and a gas supplying element; a mass flow controller disposed on the gas supply line and adapted to control a supply amount and a supply time of a gas, wherein the gas supplying element supplies the gas to the mass flow controller; and a digital pressure gauge adapted to measure the pressure of the gas and digitally display a measured pressure value of the gas. The device further comprises a database adapted to store a standard pressure value corresponding to a set flow rate; and a controller adapted to generate a first flow rate control signal, output the first flow rate control signal to the mass flow controller, receive a detected flow rate of the gas from the mass flow controller, compare the measured pressure value of the gas with a standard pressure value stored in the database corresponding to the first flow rate control signal, and output an alarm generation control signal when the measured pressure value of the gas is outside of a set error range around the standard pressure value.

In another embodiment, the invention provides a reaction gas supplying device comprising a gas supply line disposed between a process chamber and a gas supplying element; a mass flow controller disposed on the gas supply line and adapted to control a supply amount and a supply time of a gas, wherein the gas supplying element supplies the gas to the mass flow controller; and a digital pressure gauge adapted to measure the pressure of the gas and digitally display a measured pressure value of the gas. The device further comprises a controller adapted to generate a first flow rate control signal, output the first flow rate control signal to the mass flow controller, receive a detected flow rate of the gas from the mass flow controller, compare the measured pressure value of the gas with a standard pressure value corresponding to the first flow rate control signal, and output an alarm generation control signal when the measured pressure of the gas is outside of a set error range around the standard pressure value; and an alarm generator adapted to generate an alarm signal in response to the alarm generation control signal.

In yet another embodiment, the invention provides a method for sensing an error in a mass flow controller in a semiconductor fabrication device, the method comprising supplying a gas to a gas supply line disposed between a process chamber and a gas supplying element, controlling a supply amount and a supply time of the gas supplied by the gas supplying element using a mass flow controller in order to control a flow rate of the gas, and measuring a pressure of the gas in the gas supply line, wherein the pressure of the gas corresponds to the flow rate of the gas controlled by the mass flow controller. The method further comprises comparing the measured pressure with a standard pressure value, and determining whether there is an error in the mass flow controller in accordance with the compared result.

### BRIEF DESCRIPTION OF THE DRAWINGS

Embodiments of the invention will now be described with reference to the accompanying drawings, in which like reference symbols denote like elements. In the drawings:

FIG. 1 is a schematic view showing a conventional reaction gas supplying device of a semiconductor device fabrication device.

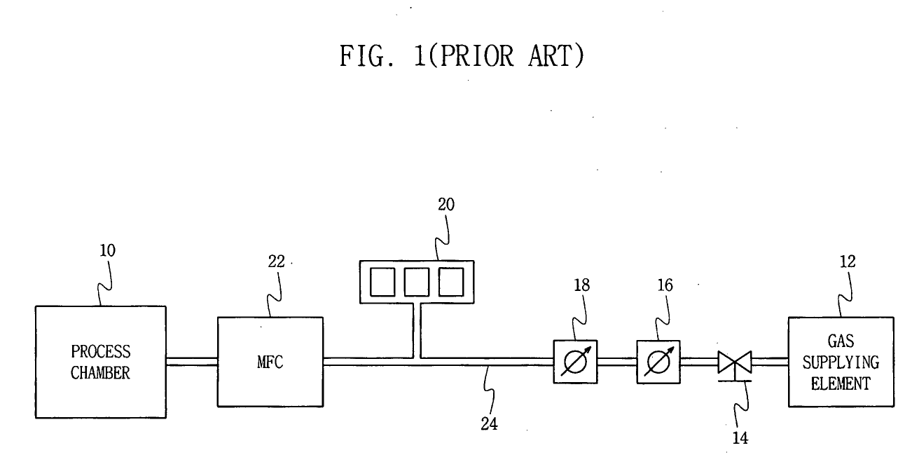

FIG. 2 is a schematic view illustrating a reaction gas supplying device of a semiconductor device fabrication device in accordance with an exemplary embodiment of the present invention;

FIG. 3 is a more detailed illustration of the MFC shown in FIG. 2; and,

FIG. 4 is a flow chart that illustrates a method for the controller of FIG. 2 for detecting whether there is an error in the MFC of FIG. 2 in accordance with an exemplary embodiment of the present invention.

### DESCRIPTION OF THE EXEMPLARY EMBODIMENTS

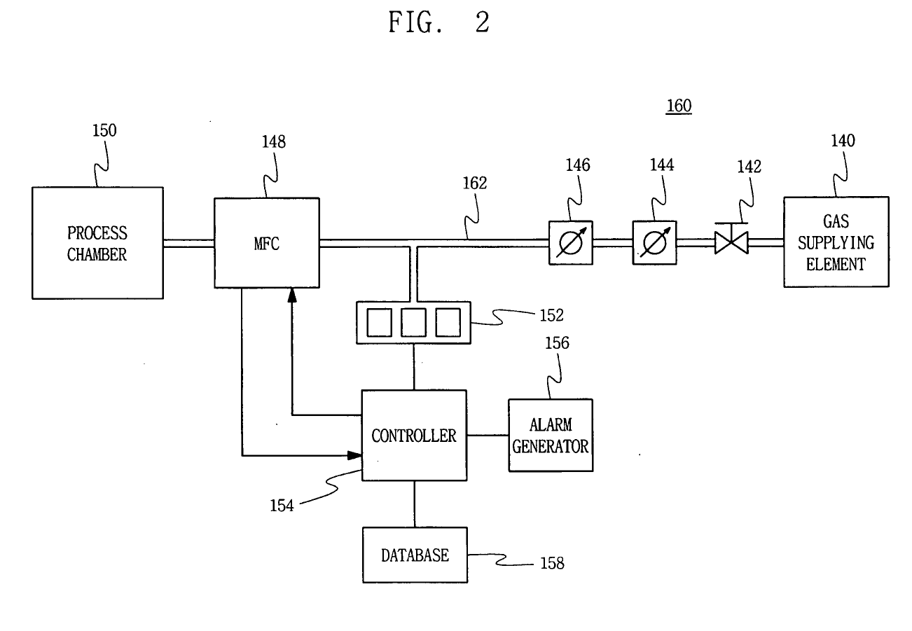

FIG. 2 is a schematic view illustrating a reaction gas supplying device of a semiconductor device fabrication device in accordance with an exemplary embodiment of the present invention.

Referring to FIG. 2, a reaction gas supplying device 160 comprises a process chamber 150, a gas supplying element 140, a main valve 142, a main pressure regulator and gauge 144, a secondary pressure regulator 146, a mass flow controller (MFC) 148, a digital pressure gauge 152, a database 158, a controller 154, and an alarm generator 156. A gas supply line 162 is disposed between process chamber 150 and gas supplying element 140. Process chamber 150 receives a gas and performs a fabrication process in an enclosed space within process chamber 150, and gas supplying element 140 stores the gas (i.e., the process gas). Main valve 142 controls whether the gas stored in gas supplying element 140 is provided to other elements in reaction gas supplying device 160. When main valve 142 is open, main pressure regulator and gauge 144 primarily adjusts the pressure (i.e., the main pressure) of the gas supplied through gas supply line 162 to give the gas a first adjusted pressure. Main pressure regulator and gauge 144 also displays the first adjusted pressure of the gas through an analog display (i.e., a gauge). Secondary pressure regulator 146 secondarily adjusts the pressure of the gas it receives from main pressure regulator and gauge 144. MFC 148 is disposed along gas supply line 162, receives the gas from secondary pressure regulator 146, and controls the supply flow rate and supply interval of the gas into process chamber 150. Digital pressure gauge 152 displays the pressure of the gas, which has been regulated by secondary pressure regulator 146, as a digital value.

Database 158 stores standard pressure values that correspond to set flow rates, and controller 154 generates a first flow rate control signal and outputs the first flow rate control signal to MFC 148 in accordance with a set flow rate. As used herein, a “set flow rate” is a flow rate at which controller 154 commands MFC 148 to maintain the gas. Thus, the first flow rate control signal that controller 154 provides to MFC 148 communicates a set flow rate to MFC 148. Controller 154 receives a detected flow rate of the gas from MFC 148. Controller 154 also compares a pressure measured by digital pressure gauge 152 with the standard pressure value, which is stored in database 158 and corresponds to the first flow rate control signal, and thus corresponds to the set flow rate that corresponds to the first flow rate control signal as well. Controller 154 outputs an alarm generation control signal when the compared result is outside a set error range. Alarm generator 156 generates an alarm signal in response to an alarm generation control signal provided by controller 154.

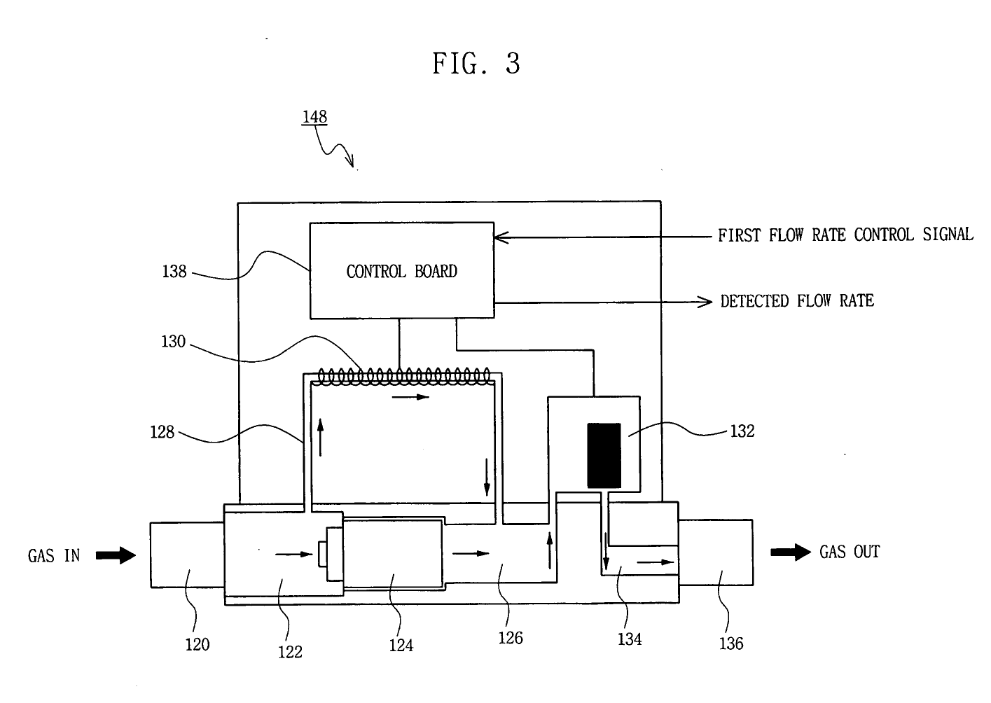

FIG. 3 is a more detailed illustration of MFC 148 shown in FIG. 2. Mass flow controller 148 comprises a gas introduction port 120, an opening portion 122, a capillary tube 128, a flow rate sensor 130, a hollow chamber 126, a bypass valve 124, a flow rate control valve 132, an exhausting passage 134, a gas exhausting port 136, a control board 138, and a check valve (not shown). Gas introduction port 120 is connected to a gas supply pipe (i.e., gas supply line 162 of FIG. 2). Opening portion 122 is connected to gas introduction port 120, and comprises a closed space therein. Gas from opening portion 122 passes through capillary tube 128, and flow rate sensor 130 detects the flow rate of the gas that passes through capillary tube 128. Hollow chamber 126 is connected to capillary tube 128, and also comprises a closed space. Bypass valve 124 is disposed between opening portion 122 and hollow chamber 126 and passes the gas so that it flows through capillary tube 128. Flow rate control valve 132 is connected to hollow chamber 126 and controls the flow rate of the gas in accordance with a second flow rate control signal. Exhausting passage 134 is connected to flow rate control valve 132, which provides the gas controlled by flow rate control valve 132 to exhausting passage 134. In accordance with the flow rate detected by flow rate sensor 130, control board 138 outputs the second flow rate control signal to flow rate control valve 132 to maintain the gas at a constant pressure. Additionally, the check valve prevents the gas from flowing in reverse, that is, flowing from exhausting passage 134 to gas introduction port 120 in MFC 148.

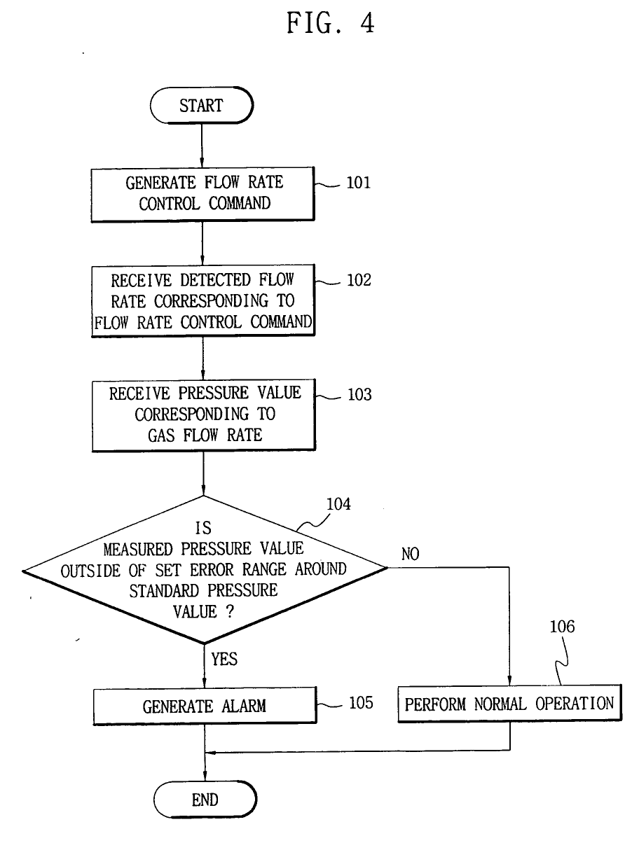

FIG. 4 is a flow chart that illustrates a method for controller 154 for detecting whether there is an error in MFC 148 in accordance with an exemplary embodiment of the present invention. Hereinafter, an operation of an exemplary embodiment of the present invention will be described with reference to FIGS. 2 through 4.

Referring to FIG. 2, the gas supply line is connected to process chamber 150, which is isolated from the external environment. Gas supply line 162 is connected to process chamber 150 and is adapted to supply the gas to process chamber 150. MFC 148 is disposed along gas supply line 162 and adjusts the supply flow rate and supply interval of the gas supplied to process chamber 150. Gas supplying element 140 is disposed at an end of the gas supply line and stores the gas.

When main valve 142 is opened, the gas stored in gas supplying element 140 is supplied through gas supply line 162. Main valve 142 is closed during maintenance times for gas supply line 162, process chamber 150, and MFC 148, but is open otherwise. When main valve 142 is open, main pressure regulator and gauge 144 primarily adjusts the pressure (i.e., the main pressure) of the gas supplied through gas supply line 162, and displays the adjusted pressure value of the gas using an analog display. For example, the primarily adjusted pressure of the gas may have a value of 8 kgf/cm². Secondary pressure regulator 146 secondarily adjusts the pressure of the gas received from main pressure regulator and gauge 144. For example, the secondarily adjusted pressure of the gas may have a value of 3 kgf/cm². The secondarily adjusted pressure of the gas is displayed digitally through digital pressure gauge 152. Secondary pressure regulator 146 then supplies the gas having the secondarily adjusted pressure to MFC 148, which supplies the gas to process chamber 150 and controls the supply flow rate and supply interval of the gas supplied to process chamber 150.

An operation of MFC 148 will now be described with reference to FIGS. 2 and 3. Gas supplying element 140 supplies a gas to opening portion 122 through gas introduction port 120. The gas provided to opening portion 122 is induced to flow into capillary tube 128 by means of bypass valve 124. The gas induced to flow into capillary tube 128 is transferred to hollow chamber 126. The gas transferred to hollow chamber 126 is then provided to flow rate control valve 132, which adjusts the flow rate of the gas, if necessary. The gas having the adjusted flow rate is then supplied to process chamber 150 through exhausting passage 134 and gas exhausting port 136. Flow rate sensor 130 detects the flow rate of the gas flowing through capillary tube 128 and provides the detected flow rate to control board 138. control board 138 receives a first flow rate control signal from controller 154 and control the amount of the gas that flows from flow rate control valve 132 in accordance with the first flow rate control signal. Control board 138 then receives a detected flow rate of the gas, as detected by flow rate sensor 130, and controls flow rate control valve 132, which controls the amount of gas that flows through exhausting passage 134. Database 158 stores standard pressures that correspond to various flow rates, as illustrated in table 1.

TABLE 1

| | Flow rate detected | Digital standard |
|---|---|---|
| Set flow rate (LPM) | by MFC (LPM) | pressure (kgf/cm²) |
| 20 | 19˜29 | 2.98˜2.99 |
| 30 | 29˜30 | 2.94˜2.95 |
| 40 | 39˜40 | 2.92 |
| 50 | 49˜50 | 2.90˜2.91 |
| 60 | 59˜60 | 2.88 |
| 70 | 69˜70 | 2.86˜2.87 |
| 80 | 79˜80 | 2.84 |

As illustrated in Table 1, there is a one-to-one correspondence between pressure of gas supply line 162 and set flow rates.

Consequently, MFC 148 sets the flow rate of the gas that will be used in a fabrication process, wherein the flow rate corresponds to a pressure value of gas supply line 162. By setting the flow rate of the gas, the pressure of the gas is set with a set error range (i.e., margin of error) of about ±0.01 kgf/cm². Controller 154 compares a pressure value detected by digital pressure gauge 152 with a standard pressures value, which corresponds to the set flow rate for the gas and is stored in database 158, and determines whether there is an error in MFC 148 (i.e., whether MFC 148 is in an error operation state) based on the result of the comparison. For example, when controller 154 generates and provides a first flow rate control signal of 80 LPM (i.e., a first flow rate control signal corresponding to a set flow rate of 80 LPM) to control board 138 of MFC 148, control board 138 sends a signal indicating that the gas has a flow rate ranging from 79 to 80 LPM to controller 154, as shown in Table 1.

Digital pressure gauge 152 measures and displays the pressure value of the gas in gas supply line 162 and provides a signal indicating the measured pressure value to controller 154. Controller 154 receives the measured pressure value from digital pressure gauge 152, and controller 154 then compares the measured pressure value with the standard pressure value of 2.84 kgf/cm², which corresponds to 80 LPM (i.e., the set flow rate). When the measured pressure value received from digital pressure gauge 152 is 2.75 kgf/cm², for example, controller 154 determines that there is an error in MFC 148 and outputs an alarm generation control signal. Alarm generator 156 generates an alarm signal in response to the alarm generation control signal received from controller 154.

FIG. 4 is a flow chart illustrating a method for controller 154 for detecting an error in MFC 148 in accordance with an exemplary embodiment of the present invention.

Referring to FIG. 4, controller 154 generates a first flow rate control signal and applies the first flow rate control signal to MFC 148 (101). When the first flow rate control signal corresponds to a set flow rate of 50 LMP (i.e., commands MFC 148 to control the flow rate of the gas at 50 LPM), for example, control board 138 of MFC 148 controls flow rate control valve 132 in order to adjust the flow rate of the gas, if necessary, so that the flow rate is set to 50 LPM. That is, control board 138 controls flow rate control valve 132 in accordance with the measured flow rate of the gas, detected by flow rate sensor 130, so that the flow rate of the gas is adjusted to 50 LPM.

After the flow rate of the gas has been adjusted, if necessary, as described previously, flow rate sensor 130 detects the flow rate of the gas and provides the resulting detected flow rate of the gas to controller 154. Next, controller 154 receives the detected flow rate of the gas from flow rate sensor 130 and determines whether the flow rate of the gas is normal (i.e., whether it corresponds to the first flow rate control signal) (102). Then, digital pressure gauge 152 provides controller 154 with a measured pressure value that corresponds to the flow rate of the gas, which is being controlled in accordance with the first flow rate control signal (103).

Thereafter, controller 154 compares the measured pressure value received from digital pressure gauge 152 with the standard pressure value that corresponds to the first flow rate control signal (and the set flow rate) and determines whether the measured pressure value falls outside of the set error range around the standard pressure value (104). When the measured pressure value is outside of the set error range around the standard pressure value, controller 154 generates an alarm generation control signal to thereby drive alarm generator 156 to generate an alarm signal (105). Alternatively, when the measured pressure value is within the set error range around the standard pressure value, a normal operation is performed (106). The set error range around the standard pressure value may be, for example, ±0.01 kgf/cm². When the measured pressure value is outside of the range of ±0.01 kgf/cm² around the standard pressure value that corresponds to the set flow rate, controller 154 determines that there is an error in MFC 148. When the set flow rate provided to MFC 148 (i.e., provided via a first flow rate control signal) is 20 LPM, the standard pressure preferably ranges from 2.98 to 2.99 kgf/cm². Accordingly, when the pressure detected in digital pressure gauge 152 is 2.97 kgf/cm² or 3.0 kgf/cm², for example, controller 154 determines that there is an error in MFC 148. As another example, when the set flow rate provided to MFC 148 is 30 LPM, the standard pressure preferably ranges from 2.94 to 2.95 kgf/cm². Accordingly, when the pressure detected by digital pressure gauge 152 is 2.93 kgf/cm² or 2.96 kgf/cm², for example, controller 154 determines that there is an error in MFC 148. Additionally, when the set flow rate provided to MFC 148 is 40 LPM, the standard pressure is preferably 2.92 kgf/cm². Accordingly, when the pressure detected by digital pressure gauge 152 is 2.91 kgf/cm² or 2.93 kgf/cm², for example, controller 154 determines that there is an error in MFC 148. When the set flow rate provided to MFC 148 is 50 LPM, the standard pressure preferably ranges from 2.90 kgf/cm² to 2.91 kgf/cm². Accordingly, when the pressure detected by digital pressure gauge 152 is 2.89 kgf/cm² or 2.92 kgf/cm², for example, controller 154 determines that there is an error in MFC 148.

As set forth above, when the flow rate of the gas is adjusted and supplied using MFC 148, when gas supply line 162 is in an abnormal state, for example, when the pressure of gas exhausting port 136 of MFC 148 becomes greater than that of gas introduction port 120 due to atmospheric exposure or a gas leak, a check value disposed at exhausting passage 134 prevents the gas from flowing in reverse. This feature prevents gas supply line 162 from being polluted and maintains the purity of the gas in gas supply line 162.

The amount of a process gas introduced into process chamber 150 for a given fabrication process depends on concentration, density, and reaction time in accordance with a reaction degree on a wafer. Ultra-thin films are treated on a wafer during etching, diffusion, oxidation, or chemical vapor deposition. Accordingly, when the amount of gas introduced into process chamber 150 or the amount of time during which gas is introduced into process chamber 150 is even slightly greater than the required amount or time, an over-reaction occurs. On the other hand, when the amount of gas introduced into process chamber 150 or the amount of time during which gas is introduced into process chamber 150 is even slightly less than the required amount or time, an under-reaction occurs, and physical properties of chemical compounds on the wafer vary and a circuit is improperly formed as a result. For these reasons, MFC 148, which adjusts the amount of process gas supplied into process chamber 150, must be very precise and sufficiently durable so that the flow rate is not changed due to frequent flow rate control operations.

As mentioned above, a gas supplying device, in accordance with the present invention, detects and compares a standard pressure value corresponding to a set flow rate of a gas controlled by the MFC of a semiconductor production device with a measured pressure value. When the measured pressure value is outside of a set error range around the standard pressure value, the gas supplying device determines that there is an error in the MFC and generates an alarm. Therefore, the present invention is adapted to prevent a process error due to a failure of the MFC in order to reduce semiconductor device fabrication cost.

The present invention has been described with reference to exemplary embodiments. However, it will be understood that the scope of the invention is not limited to the disclosed embodiments. Rather, various modifications and alternative arrangements within the capabilities of persons skilled in the art are within the scope of the present invention, as described in the accompanying claims. Therefore, the scope of the claims should be accorded the broadest possible interpretation to encompass all such modifications and similar arrangements.

What is claimed is:

1. A reaction gas supplying device comprising:
a gas supply line disposed between a process chamber and a gas supplying element;
a mass flow controller disposed along the gas supply line and adapted to control a supply flow rate and a supply interval for a gas;
a digital pressure gauge adapted to measure the pressure of the gas in the gas supply line and digitally display a measured pressure value of the gas;
a database adapted to store a standard pressure value corresponding to a set flow rate; and,
a controller adapted to generate a first flow rate control signal, output the first flow rate control signal to the mass flow controller, receive a detected flow rate of the gas from the mass flow controller, compare the measured pressure value of the gas with a standard pressure value stored in the database corresponding to the first flow rate control signal, and output an alarm generation control signal when the measured pressure value of the gas is outside of a set error range around the standard pressure value.

2. The apparatus of claim 1, further comprising an alarm generator adapted to generate an alarm signal in response to the alarm generation control signal.

3. The apparatus of claim 2, wherein the mass flow controller comprises:
an opening portion connected to a gas introduction port and comprising a closed space;
a hollow chamber connected to a capillary tube and comprising a closed space, wherein the capillary tube is adapted to provide gas from the opening portion to the hollow chamber;
a flow rate sensor adapted to detect the flow rate of the gas passing through the capillary tube;
a bypass valve disposed between the opening portion and the hollow chamber and adapted to guide the gas to flow through the capillary tube;
a flow rate control valve connected to the hollow chamber and adapted to control the flow rate of the gas in accordance with a second flow rate control signal;
an exhausting passage connected to the flow rate control valve and adapted to receive the gas from the flow rate control valve and output the gas;
a control board adapted to output the second flow rate control signal to the flow rate control valve to maintain a constant pressure in accordance with the flow rate detected by the flow rate sensor; and,
a check valve adapted to prevent the gas from flowing in reverse from the exhausting passage to the gas introduction port.

4. The apparatus of claim 3, wherein the check valve is disposed in the exhausting passage.

5. The apparatus of claim 3, wherein the set error range is ±0.01 kgf/cm² around the standard pressure value.

6. A reaction gas supplying device comprising:
a gas supply line disposed between a process chamber and a gas supplying element;
a mass flow controller disposed along the gas supply line and adapted to control a supply flow rate and a supply interval for a gas, wherein the gas supplying element supplies the gas to the mass flow controller;
a digital pressure gauge adapted to measure the pressure of the gas in the gas supply line and digitally display a measured pressure value of the gas;
a controller adapted to generate a first flow rate control signal, output the first flow rate control signal to the mass flow controller, receive a detected flow rate of the gas from the mass flow controller, compare the measured pressure value of the gas with a standard pressure value corresponding to the first flow rate control signal, and output an alarm generation control signal when the measured pressure of the gas is outside of a set error range around the standard pressure value; and,
an alarm generator adapted to generate an alarm signal in response to the alarm generation control signal.

7. The apparatus of claim 6, wherein the mass flow controller comprises:
an opening portion connected to a gas introduction port and comprising a closed space;
a hollow chamber connected to a capillary tube and comprising a closed space, wherein the capillary tube is adapted to provide gas from the opening portion to the hollow chamber;
a flow rate sensor adapted to detect the flow rate of the gas passing through the capillary tube;
a bypass valve disposed between the opening portion and the hollow chamber and adapted to guide the gas to flow through the capillary tube;
a flow rate control valve connected to the hollow chamber and adapted to control the flow rate of the gas in accordance with a second flow rate control signal;
an exhausting passage connected to the flow rate control valve and adapted to receive the gas from the flow rate control valve and output the gas;
a control board adapted to output the second flow rate control signal to the flow rate control valve to maintain a constant pressure in accordance with the flow rate detected from the flow rate sensor; and,
a check valve adapted to prevent the gas from flowing reverse from the exhausting passage to the gas introduction port.

8. The apparatus of claim 7, wherein the check valve is disposed in the exhausting passage.

9. The apparatus of claim 8, wherein the set error range is ±0.01 kgf/cm².

10. A method for sensing an error in a mass flow controller in a semiconductor fabrication device, the method comprising:
(i) supplying a gas to a gas supply line disposed between a process chamber and a gas supplying element;
(ii) controlling a supply flow rate and a supply interval for the gas supplied by the gas supplying element using a mass flow controller in order to control a flow rate of the gas;
(iii) measuring a pressure of the gas in the gas supply line, wherein the pressure of the gas corresponds to the flow rate of the gas controlled by the mass flow controller; and,
(iv) comparing the measured pressure with a standard pressure value, and determining whether there is an error in the mass flow controller in accordance with the compared result.

11. The apparatus of claim 10, further comprising generating an alarm signal when there is an error in the mass flow controller.

12. The method of claim 11, wherein determining whether there is an error in the mass flow controller in accordance with the compared result comprises determining that there is an error in the mass flow controller when the measured pressure is outside of a set error range around the standard pressure value.

13. The method of claim 12, wherein the set error range is ±0.01 kgf/cm².
